(19) United States
(12) Patent Application Publication
(10) Pub. No.: US 2023/0026110 A1
(43) Pub. Date: Jan. 26, 2023

(54) LEARNING DATA GENERATION METHOD, LEARNING DATA GENERATION APPARATUS AND PROGRAM

(71) Applicant: NIPPON TELEGRAPH AND TELEPHONE CORPORATION, Tokyo (JP)

(72) Inventors: Itsumi SAITO, Tokyo (JP); Kyosuke NISHIDA, Tokyo (JP); Hisako ASANO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/785,967

(22) PCT Filed: Dec. 18, 2019
(86) PCT No.: PCT/JP2019/049661

§ 371 Date: Jun. 16, 2022

(51) Int. Cl. G06K 9/62; G06F 40/40

(52) U.S. Cl. CPC G06K 9/6256; G06F 40/40

(57) ABSTRACT

In a training data generation method, a computer executes: a generation step for generating partial data of a summary sentence created for text data; an extraction step for extracting, from the text data, a sentence set that is a portion of the text data, based on a similarity with the partial data; and a determination step for determining whether or not the partial data is to be used as training data for a neural network that generates a summary sentence, based on the similarity between the partial data and the sentence set. Thus, it is possible to streamline the collection of training data for a neural summarization model.

### TECHNICAL FIELD

The present invention relates to a training data generation method, a training data generation device, and a program.

### BACKGROUND ART

A neural summarization model requires pair data of a source text to be summarized and summary data that is the correct answer for the summarization as training data. Alternatively, there is also a model that requires additional parameters as training data with respect to the pair data (e.g., NPL 1). In either model, the more training data there is, the higher the accuracy of summarization will be.

### CITATION LIST

### Non-Patent Literature

[NPL 1] Gonçalo M. Correia, André F. T. Martins, A Simple and Effective Approach to Automatic Post-Editing with Transfer Learning, Proceedings of the 57th Annual Meeting of the Association for Computational Linguistics, pages 3050-3056, July 28-Aug. 2, 2019.

### SUMMARY OF THE INVENTION

### Technical Problem

It is necessary to manually create the summary data that is the correct answer for the summarization in the above training data. However, collecting large amounts of manually-created, high-quality summary data is costly.

The present invention has been made in view of the above points, and an object of the present invention is to improve the efficiency of collecting training data for a neural summarization model.

### Means for Solving the Problem

In view of this, in order to solve the above-described problem, in a training data generation method, a computer executes: a generation step of generating partial data of a summary sentence created for text data; an extraction step of extracting, from the text data, a sentence set that is a portion of the text data, based on a similarity with the partial data; and a determination step of determining whether or not the partial data is to be used as training data for a neural network for generating a summary sentence, based on a similarity between the partial data and the sentence set.

### Effects of the Invention

It is possible to streamline the collection of training data for the neural summarization model.

### BRIEF DESCRIPTION OF DRAWINGS

FIG. 1 is a diagram showing an example of a hardware configuration of a training data generation device 10 according to an embodiment of the present invention.

FIG. 2 is a diagram showing an example of a functional configuration of the training data generation device 10 according to the embodiment of the present invention.

FIG. 3 is a flowchart for illustrating an example of a processing procedure executed by the training data generation device 10.

FIG. 4 is a diagram showing an example of partial data.

FIG. 5 is a diagram showing an example of extracting prototype text.

FIG. 6 is a diagram showing an example of calculating a ROUGE.

### DESCRIPTION OF EMBODIMENTS

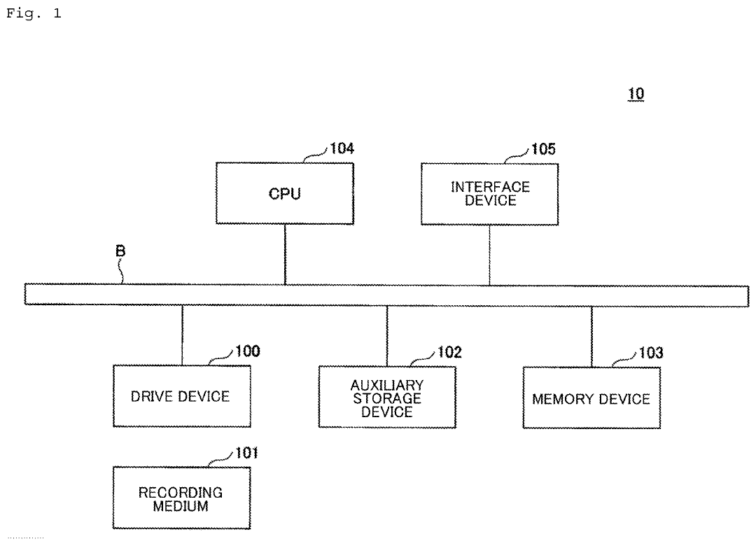

Hereinafter, embodiments of the present invention will be described with reference to the drawings. FIG. 1 is a diagram showing a hardware configuration example of the training data generation device 10 according to an embodiment of the present invention. The training data generation device 10 of FIG. 1 has a drive device 100, an auxiliary storage device 102, a memory device 103, a CPU 104, an interface device 105, and the like, which are connected to each other by a bus B.

The program that realizes the processing in the training data generation device 10 is provided by a recording medium 101 such as a CD-ROM. When the recording medium 101 storing the program is set in the drive device 100, the program is installed in the auxiliary storage device 102 from the recording medium 101 via the drive device 100. However, the program does not necessarily need to be installed from the recording medium 101, and may be downloaded from another computer via a network. The auxiliary storage device 102 stores the installed program and stores necessary files, data, and the like.

If there is a program startup instruction, the memory device 103 reads out the program from the auxiliary storage device 102 and stores the read-out program. The CPU 104 executes the function related to the training data generation device 10 in accordance with the program stored in the memory device 103. The interface device 105 is used as an interface for connecting to a network.

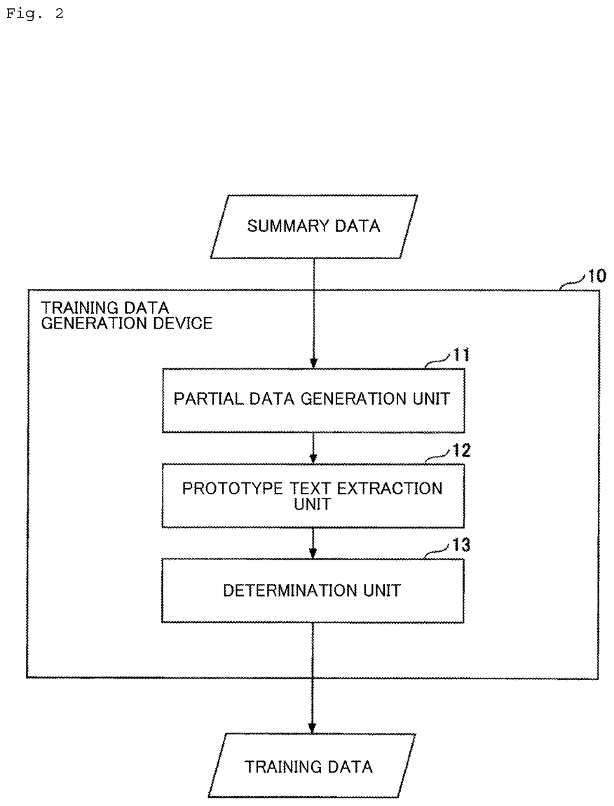

FIG. 2 is a diagram showing an example of a functional configuration of the training data generation device 10 according to the embodiment of the present invention. In FIG. 2, the training data generation device 10 has a partial data generation unit 11, a prototype text extraction unit 12, and a determination unit 13. Each of these units is realized through processing that one or more programs installed in the training data generation device 10 cause the CPU 104 to execute.

The partial data generation unit 11 generates partial data of a summary sentence created for a source text (text data to be summarized).

The prototype text extraction unit 12 extracts a sentence set (hereinafter referred to as “prototype text”) that is a portion of the source text from the source text based on the similarity with the partial data.

The determination unit 13 determines whether or not to use the partial data as training data for the neural summarization model based on the similarity between the partial data and the prototype text. Note that the neural summarization model is a neural network that generates a summary sentence for an input sentence (source text).

Note that in the present embodiment, training data for a neural summarization model that requires a third parameter in addition to the source text and the summary sentence that is the correct answer is generated as the training data. In the present embodiment, the prototype text corresponds to this parameter.

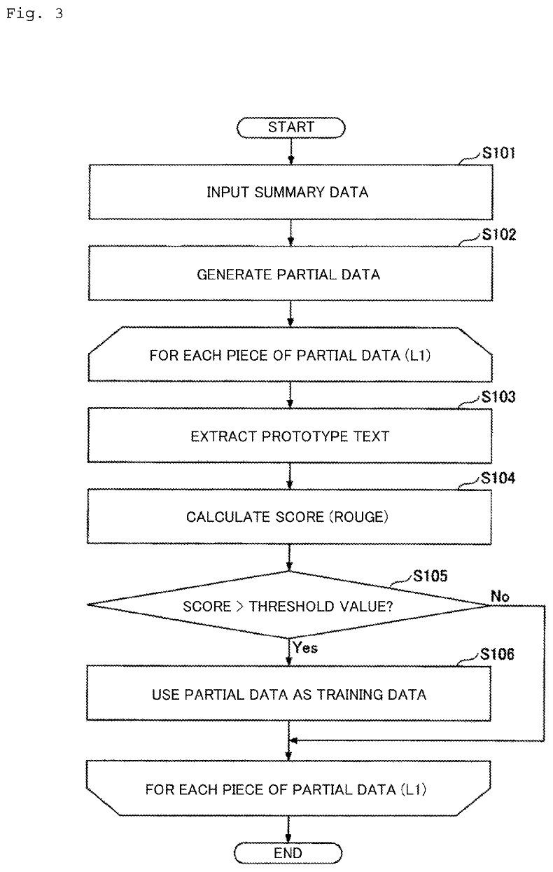

Hereinafter, a processing procedure executed by the training data generation device 10 will be described. FIG. 3 is a flowchart for illustrating an example of the processing procedure executed by the training data generation device 10.

In step S101, the partial data generation unit 11 inputs data (hereinafter referred to as “target summary data”) indicating one summary sentence created in advance for text data to be summarized (hereinafter referred to as “target source text”) to the training data for the neural summarization model. The target summary data may include one or more sentences. Alternatively, the target summary data may be data in the form of a list of one or more sentence sets.

Subsequently, the partial data generation unit 11 divides the target summary data into units of sentences, and generates partial data obtained by combining (joining) one or more of the divided sentences (S102). Note that if the target summary data is a list of sentence sets, partial data obtained by dividing the target summary data into units of sentence sets and combining one or more sentence sets may be generated.

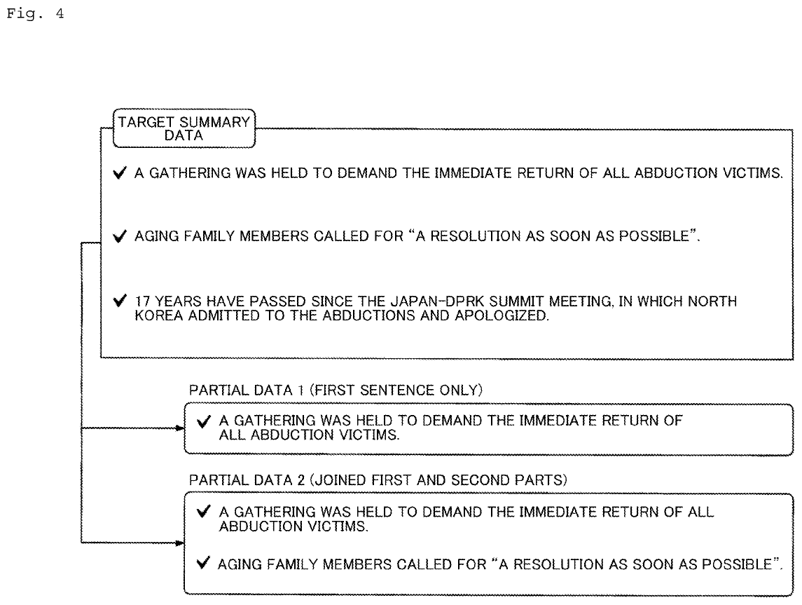

FIG. 4 is a diagram showing an example of partial data. FIG. 4 shows an example of partial data generated based on the target summary data in list format. In FIG. 4, partial data 1 includes only the first sentence of the target summary data. Partial data 2 includes the first sentence and the second sentence of the target summary data.

Note that a combination of other sentences may also be generated as partial data. At this time, the result of joining together sentences that are not continuous in the target summary data may also be used as partial data. Also, all combinations of sets of sentences included in the target summary data may be generated as partial data.

Subsequently, loop processing L1 including steps S103 to S106 is executed for each piece of generated partial data. The partial data to be processed in the loop processing L1 is hereinafter referred to as “target partial data”.

In step S103, the prototype text extraction unit 12 extracts a portion of the target source text (a set of one or more sentences) having the highest similarity (matching) with the target part data as a prototype text.

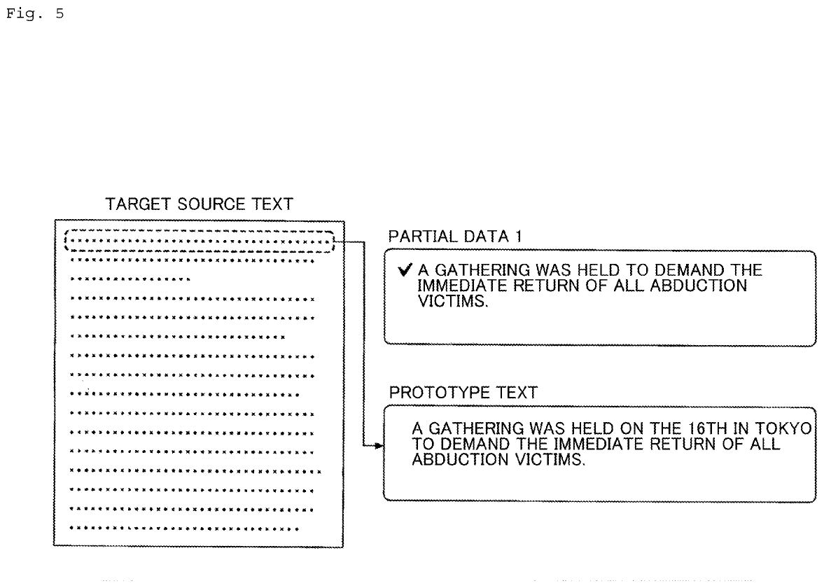

FIG. 5 is a diagram showing an example of extracting the prototype text. FIG. 5 shows an example in which the partial data 1 is the target partial data and the first sentence of the target source text is extracted as the prototype text for the partial data 1.

For example, the prototype text extraction unit 12 calculates the degree of similarity or the degree of matching (ROUGE) of each sentence of the target partial data and the target source text, and extracts the sentence set having the highest ROUGE in the target source text as the prototype text. At this time, the prototype text may also be extracted using a learned extraction model.

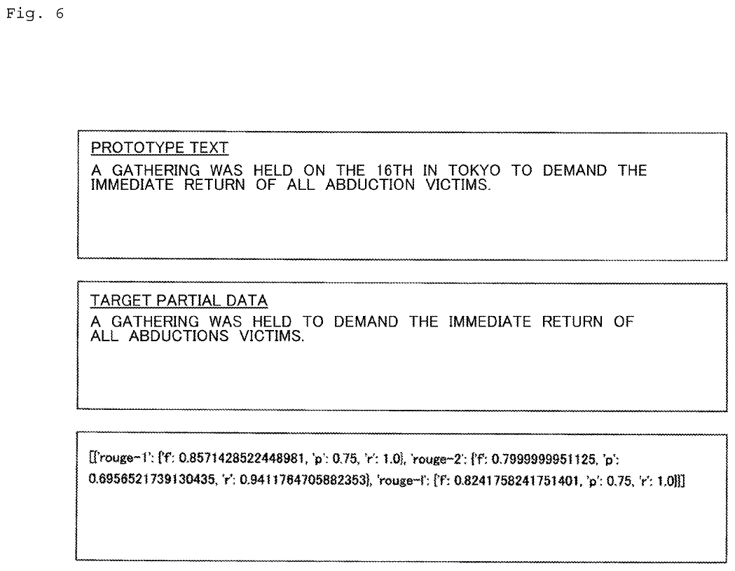

Subsequently, the determination unit 13 calculates the degree of similarity or the degree of matching (ROUGE) between the prototype text and the target partial data as the score of the target partial data (S104). At this time, the determination unit 13 divides each of the prototype text and the target partial data into words using morpheme analysis or the like as shown in FIG. 6, and calculates the F score of ROUGE-L. Note that in the example of FIG. 6, the F score of ROUGE-L is 0.824.

Subsequently, the determination unit 13 compares the score (F score) and a threshold value (S105). If the score exceeds the threshold value, the determination unit 13 determines that the target partial data is to be used as a component of the training data (training data for the neural summarization model) serving as the summary sentence for the target source text (S106). In this case, a group consisting of the target source text, the prototype text, and the target partial data serves as the training data.

On the other hand, if the score is less than or equal to the threshold value, the determination unit 13 determines that the target partial data is not to be used as a component of the training data of the summary sentence for the target source text.

For example, in a case where the F score is 0.824 as described above, if the threshold value is 0.5, the target partial data is used as a component of the training data of the summary sentence for the target source text.

As described above, according to the present embodiment, a new summary sentence is automatically generated as training data based on the summary sentence created in advance as training data for the neural summarization model (the training data can be expanded). Accordingly, it is possible to streamline the collection of training data for the neural summary model. As a result, it is possible to expect improvement of the accuracy of the neural summarization model.

Note that in the case of normal generation-type summarization, since content extraction and sentence generation are learned at the same time, generating and adding a plurality of summarization patterns based on one source text results in noise and thus is inefficient. On the other hand, in the case of a model in which extraction and generation are learned separately and generation is performed while using the extraction result as a reference at the time of generation, rewriting based on the extraction result is mainly learned, and therefore even if multiple pieces of summary data are generated based on one source text, noise does not result (the content is controlled by an extraction module).

That is, it is also conceivable that the rewritten data from extraction to generation is extended in the extension of the training data according to the present embodiment. In this case, if the data has at least a certain degree of similarity with the extraction result, it is possible to expect improvement of the accuracy by using the data as effective training data.

Note that in the present embodiment, the partial data generation unit 11 is an example of a generation unit. The prototype text extraction unit 12 is an example of an extraction unit.

Although the embodiments of the present invention have been described in detail above, the present invention is not limited to such specific embodiments, and various modifications and changes can be made within the scope of the gist of the present invention described in the claims.

### REFERENCE SIGNS LIST

10 Training data generation device
11 Partial data generation unit
12 Prototype text extraction unit
13 Determination unit
100 Drive device
101 Recording medium
102 Auxiliary storage device
103 Memory device
104 CPU
105 Interface device
B Bus

1. A training data generation method to be executed by a computer, the method comprising:
generating partial data of a summary sentence created for text data;
extracting, from the text data, a sentence set including a portion of the text data, based on a similarity with the partial data; and
determining whether or not the partial data is to be used as training data for a neural network for generating a summary sentence, based on a similarity between the partial data and the sentence set.

2. The training data generation method according to claim 1, wherein the determining comprises calculating a degree of similarity of a degree of matching (ROUGE) of the partial data and the sentence set, and determining whether or not the partial data is to be used as the training data based on a comparison of the ROUGE and a threshold value.

3. The training data generation method according to claim 1, wherein the partial data includes a combination of one or more sentences included in the summary sentence.

4. A training data generation device comprising a processor configured to execute a method comprising:
generating partial data of a summary sentence created for text data;
extracting, from the text data, a sentence set that is a portion of the text data, based on a similarity with the partial data; and
determining whether or not the partial data is to be used as training data for a neural network for generating a summary sentence, based on a similarity between the partial data and the sentence set.

5. The training data generation device according to claim 4, wherein the determining further comprises calculating degree of similarity of a degree of matching (ROUGE) of the partial data and the sentence set, and determining whether or not the partial data is to be used as the training data based on a comparison of the ROUGE and a threshold value.

6. The training data generation device according to claim 4, wherein the partial data includes a combination of one or more sentences included in the summary sentence.

7. A computer-readable non-transitory recording medium storing computer-executable program instructions that when executed by a processor cause a computer to execute a training data generation method comprising:
generating partial data of a summary sentence created for text data;
extracting, from the text data, a sentence set that is a portion of the text data, based on a similarity with the partial data; and
determining whether or not the partial data is to be used as training data for a neural network for generating a summary sentence, based on a similarity between the partial data and the sentence set.

8. The training data generation method according to claim 1, wherein the extracting further comprises extracting, from the text data, the sentence set including the portion of the text data indicating the highest similarity with the partial data.

9. The training data generation method according to claim 1, wherein the similarity between the partial data and the sentence set is based on Recall-Oriented Understudy for Gisting Evaluation (ROUGE).

10. The training data generation method according to claim 1, wherein the determining further comprises determining a score associated with ROUGE based on Longest Common Subsequence (ROUGE-L).

11. The training data generation method according to claim 1, wherein the determining further comprises determining to use the partial data as training data for the neural network for generating a summary sentence when the similarity between the partial data and the sentence set is greater than a predetermined threshold.

12. The training data generation device according to claim 4, wherein the extracting further comprises extracting, from the text data, the sentence set including the portion of the text data indicating the highest similarity with the partial data.

13. The training data generation device according to claim 4, wherein the similarity between the partial data and the sentence set is based on Recall-Oriented Understudy for Gisting Evaluation (ROUGE).

14. The training data generation device according to claim 4, wherein the determining further comprises determining a score associated with ROUGE based on Longest Common Subsequence (ROUGE-L).

15. The training data generation device according to claim 4, wherein the determining further comprises determining to use the partial data as training data for the neural network for generating a summary sentence when the similarity between the partial data and the sentence set is greater than a predetermined threshold.

16. The computer-readable non-transitory recording medium according to claim 7, wherein the determining further comprises calculating degree of similarity of a degree of matching (ROUGE) of the partial data and the sentence set, and determining whether or not the partial data is to be used as the training data based on a comparison of the ROUGE and a threshold value.

17. The computer-readable non-transitory recording medium according to claim 7, wherein the partial data includes a combination of one or more sentences included in the summary sentence.

18. The computer-readable non-transitory recording medium according to claim 7, wherein the extracting further comprises extracting, from the text data, the sentence set including the portion of the text data indicating the highest similarity with the partial data.

19. The computer-readable non-transitory recording medium according to claim 7, wherein the similarity between the partial data and the sentence set is based on Recall-Oriented Understudy for Gisting Evaluation (ROUGE), and
wherein the determining further comprises determining a score associated with ROUGE based on Longest Common Subsequence (ROUGE-L).

20. The computer-readable non-transitory recording medium according to claim 7, wherein the determining further comprises determining to use the partial data as training data for the neural network for generating a summary sentence when the similarity between the partial data and the sentence set is greater than a predetermined threshold.
